(19) United States
(12) Patent Application Publication
(10) Pub. No.: US 2013/0160721 A1
(43) Pub. Date: Jun. 27, 2013

(54) MOUNTAIN PAWSUIT

(71) Applicant: Katherine J. Cain, Yampa, CO (US)

(72) Inventor: Katherine J. Cain, Yampa, CO (US)

(21) Appl. No.: 13/725,436

(22) Filed: Dec. 21, 2012

Related U.S. Application Data
(60) Provisional application No. 61/579,503, filed on Dec. 22, 2011.

(51) Int. Cl. A01K 29/00

(52) U.S. Cl. CPC A01K 29/00
USPC 119/850

(57) ABSTRACT

A garment for a pet includes a body portion and leg portions. The garment can include an anterior opening, a posterior opening, and a lower opening. A foot portion is located at the lower end of each leg portion and can include a foot-reinforcement region. A foot-retention mechanism facilitates retention of the foot of the pet within the foot portion.

### CROSS-REFERENCE TO RELATED APPLICATION

This application claims priority from U.S. Provisional Application No. 61/579,503, filed on Dec. 22, 2011, entitled “MOUNTAIN PAWSUIT,” which is incorporated herein by reference in its entirety for all purposes.

### BACKGROUND

Pet garments (e.g., blankets, sweaters, etc.) can provide warmth, protection, and style to the pets that wear them. Often, dressing a pet in a conventional pet garment can be difficult as many conventional pet garments are placed on the pet by slipping the garment over the pet's head and pushing the pet's legs through the sleeves. Pets sometimes squirm or wiggle while being dressed, complicating the dressing process. Standalone paw covers are difficult to put on, but easily fall off with normal pet activity. Additionally, conventional pet garments typically leave a pet's paws exposed, for example to snow, ice, rocks, and/or pine needles.

### SUMMARY

This summary is provided to introduce a selection of concepts in a simplified form that are further described below in the Detailed Description. This summary is not intended to identify key features or essential features of the claimed subject matter, nor is it intended to be used, in isolation, as an aid in determining the scope of the claimed subject matter. At a high level, embodiments of the invention relate to a garment that can be worn by a pet such as, for example, a dog, a cat, a pig, a ferret, and the like. In embodiments, the garment may provide warmth, protection from wind, protection from precipitation, and the like.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The present invention is described in detail below with reference to the attached drawing figures, wherein:

FIG. 1 depicts a side view of a pet wearing a pet garment in accordance with embodiments of the invention;

FIG. 2 depicts a front view of a pet wearing a pet garment in accordance with embodiments of the invention;

FIG. 3 depicts a back view of a pet wearing a pet garment in accordance with embodiments of the invention;

FIG. 4 depicts a bottom view of a pet wearing a pet garment in accordance with embodiments of the invention; and

FIG. 5 depicts a bottom-perspective view of a pet wearing a pet garment in accordance with embodiments of the invention.

### DETAILED DESCRIPTION

The subject matter of embodiments of the invention is described with specificity to meet statutory requirements. However, the description itself is not intended to limit the scope of this patent. Rather, the claimed subject matter can also be embodied in other ways, to include different features or combinations of features similar to the ones described herein, in conjunction with other technologies. Embodiments of the invention include a garment that can be worn by a pet such as, for example, a dog, a cat, a pig, a ferret, or the like. In embodiments, the garment may provide warmth, protection from wind, protection from precipitation, or the like.

The winter months in many regions (e.g., the Rocky Mountains) of the country can include extreme weather conditions. In many of these regions, the ground can be snow-covered for many months and, with temperatures often dropping well below freezing, the snow can be painful for a pet's paws when going for a walk. In some cases, for example, dogs will hop on one paw to alleviate the discomfort. Embodiments of the pet garment described herein can protect the pet's paws. Embodiments of the pet garment can be easy for a pet owner to put onto the pet and keep track of (e.g., in embodiments in which the pet garment is constructed from one piece of material).

Traditionally, pet owners have often used separate booties that can be put onto each paw of the pet to protect the pet's paws. These booties often can come off of the pet's paws while the pet is walking, increasing the chance of losing the booties. Embodiments of the pet garment include a garment that generally will not easily come off of the pet while the pet is walking. Additionally, in embodiments, the pet garment is made from polar fleece, which wicks away moisture in the event of snow or sleet while walking, and keeps the pet garment lightweight on the pet even when wet. Additionally, polar fleece is relatively easy to wash and dry. In embodiments, openings on the underside and posterior portions of the pet garment allow the pet freedom of movement, as well as freedom to relieve itself While the pet garment described herein was conceptualized for use in snow-covered mountain areas, it could easily be used in any area (e.g., plains, cities, suburbs, etc.) where the pet garment could be used to protect various types of pets from adverse weather conditions.

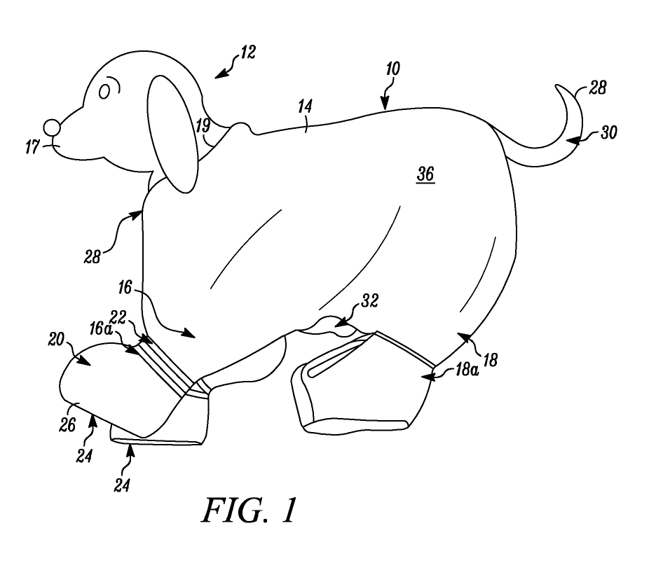

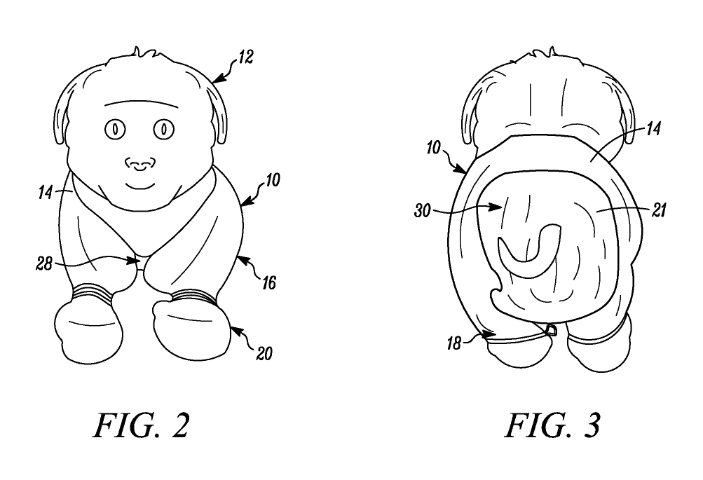

FIGS. 1-5 depict a garment 10 that is being worn by a pet 12. The garment 10 can be adapted to be worn by any number of different types of pets including, for example, a dog, a cat, a pig, a ferret, or the like. Embodiments of the garment 10 can be of a size that is appropriate for a particular type of pet 12. As shown in FIG. 1, the garment 10 includes a body portion 14, leg portions 16 and 18 (e.g., front-leg portions 16 and back-leg portions 18), and foot portions 20. The embodiments shown in FIGS. 1-5 are not intended to suggest any limitation as to the scope of use or functionality of embodiments of the invention disclosed throughout this document. Neither should the embodiments shown in FIGS. 1-5 be interpreted as having any dependency or requirement related to any single component or combination of components illustrated therein. For example, various embodiments of the garment 10 can include additional features such as pockets, fastening devices (e.g., zippers, snaps, buttons, etc.), integrated collars, and the like, all of which are considered to be within the ambit of the invention.

According to various embodiments, the garment 10 can be constructed of a single piece of material. In other embodiments, the garment 10 can be constructed of a number of pieces of material that may, in embodiments, be coupled to one another using any number of various coupling mechanisms. For example, in some embodiments, pieces of material can be sewn, stapled, snapped, buttoned, coupled using a hook-and-loop fastening device (e.g., Velcro®), coupled using a zipper, or the like.

Additionally, in some embodiments, the garment 10 can be made from one type of material, while, in other embodiments, the garment 10 can be made from a number of different types of material. For example, in an embodiment, the body portion 14 can be made from a first material and the leg portions 16 and 18 can be made from a second material. Examples of materials that can be used to construct portions of the garment 10 include fleece (e.g., polar fleece), wool, cotton, polyester, leather, suede, velvet, burlap, plastic, vinyl, nylon, and the like. According to various embodiments, the garment 10 can include a liner disposed over at least a portion of the inside of the garment 10.

As shown in FIGS. 1-5, the body portion 14 of the garment 10 covers at least a portion of the body 15 of the pet 12. In some embodiments, the body portion 14 can cover the entire body 15 of the pet 12, while, in other embodiments, the body portion 14 can cover a portion of the body 15 of the pet 12. The front-leg portions 16, which extend from the body portion 14, cover at least a portion of each of the front legs (not shown) of the pet 12 and the back-leg portions 18, which extend from the body portion 14, cover at least a portion of the back legs (not shown) of the pet 12. In the pictured embodiments, the garment 10 includes two front-leg portions 16 and two back-leg portions 18. However, in some embodiments, the garment 10 can include any number of leg portions 16, 18, depending upon the number of corresponding legs on the pet 12. For example, in some cases, a pet 12 may have lost a leg, in which case, the garment 10 can include a total of three leg portions 16, 18.

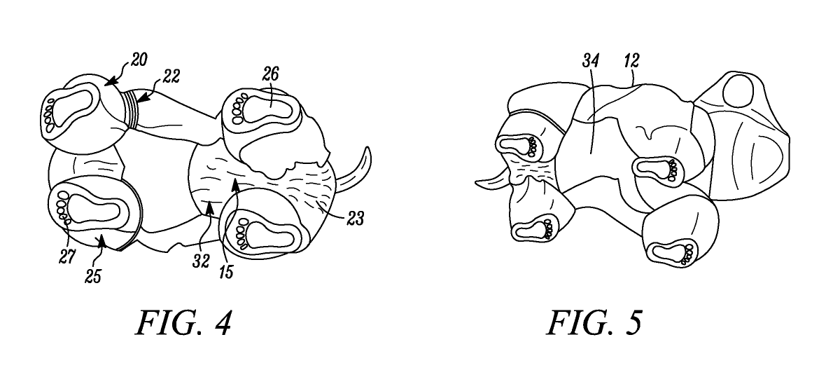

According to embodiments, the foot portions 20 cover at least a portion of each of the feet (e.g., paws) (not shown) of the pet 12. In embodiments, each foot portion 20 extends from a lower end 16a and 18a, of each leg portion 16 and 18, respectively. As shown in FIGS. 1 and 4, in an embodiment, each foot portion 20 covers the entire foot of the pet 12. In other embodiments, the foot portion 20 can include an opening at the bottom to expose the bottom (e.g., pad) (not shown) of the pet's foot. In other embodiments, the foot portion 20 can include an opening on the top, side, front, or back, to expose other portions of the pet's foot. According to some embodiments of the present invention, each foot portion 20 is entirely closed in order to protect the pet's paw. Each foot portion 20 may be water proof, water resistant, and/or may include a water resistant material in its construction. The inside of each foot portion 20 (not shown) may include padding material in order to add to the pet's comfort. For example, each foot portion 20 may include extra foam and/or padding on the inside so as to make the inside of each foot portion 20 similar to a cushy or comfortable slipper. As such, when the pet wears the garment 10 outside into harsh conditions (for example, conditions similar to those experienced in the Rocky Mountains in winter time), the pet will experience a high degree of comfort and functionality from the garment 10, according to embodiments of the present invention.

In some embodiments, the garment 10 includes a foot-retention mechanism 22 to facilitate retention of the foot of the pet 12 in the foot portion 20. In embodiments, the foot-retention mechanism 22 wraps around at least a portion of the leg of the pet 12, keeping the foot portion 20 from moving off of the foot of the pet 12. According to various embodiments, the foot-retention mechanism 22 can be integrated within the garment 10 and, in other embodiments, the foot-retention mechanism 22 can be applied to the worn garment 10. In embodiments, the foot-retention mechanism 22 can be constructed of any number of materials such as, for example, elastomeric fabric, rubber, plastic, and the like. For example, in an embodiment, the foot-retention mechanism 22 can include a piece of elastic that is sewn into garment 10 at a location above the foot portion 20 and below the body portion 14. In some embodiments, the foot-retention mechanism 22 can be adjustable such as, for example, by including a button disposed on the outside of the garment 10 that is adapted to engage one of a number of apertures defined within a protruding portion of an elastomeric fabric. Any number of other adjustment mechanisms can also be used to provide an adjustable foot-retention mechanism 22.

As depicted in FIGS. 1 and 4, the garment 10 can include one or more foot-reinforcement regions 24. Each foot-reinforcement region 24 can be disposed at a lower end 25 of a leg portion 16, 18. According to embodiments, the foot-reinforcement regions 24 can include a portion of the garment 10 that is thicker than other portions of the garment 10, thereby providing protection of the pet's foot from abrasion, rough terrain, cold temperatures, snow, ice, and the like. In embodiments, a foot-reinforcement region 24 can be constructed of any number of different types of materials such as, for example, plastic, rubber, vinyl, nylon, or the like. In some embodiments, the foot-reinforcement region(s) 24 can be attached to the garment 10 (e.g., sewn, buttoned, snapped, etc.). In other embodiments, the foot-reinforcement region(s) 24 can be integrated within the garment 10. Additionally, in some embodiments, the foot-reinforcement region(s) 24 can include tread features 27 that can provide traction for the pet 12 as it walks or runs while wearing the garment 10.

As indicated above, embodiments of the garment 10 can include a body portion 14 that covers a portion of the body of the pet 12. In embodiments, the body portion 14 can include an anterior opening 28 that allows at least a portion of anterior of the pet 12 to be exposed (e.g., the head 17, the neck 19, etc.). Additionally, in embodiments, the body portion 14 can include a posterior opening 30 that allows at least a portion of the posterior region 21 of the pet 12 to be exposed (e.g., to minimize contact between urine, feces, and the like, with the garment 10). Similarly, in some embodiments, the garment 10 can include a lower opening 32 that allows at least a portion of the underside 23 of the pet 12 to be exposed. In some embodiments, the garment 10 includes a body portion 14 having an anterior opening 28, a posterior opening 30, and a lower opening 32 so that the garment 10 can be placed on the pet 12 by placing the body portion 14 of the garment over the back (not shown) of the pet 12 and placing the feet of the pet 12 into the foot portions 20.

According to some embodiments, the garment 10 can include an underbelly portion 34 that can be disposed over at least a portion of the underside 23 of the pet 12. In some embodiments, the underbelly portion 34 can be removably attachable to the body portion 14 of the garment 10. In other embodiments, the underbelly portion 34 can be removably attachable to one or more of the leg portions 16, 18 of the garment 10. In some embodiments, the underbelly portion 34 can be removably attachable to the body portion 14 and one or more of the leg portions 16, 18. Additionally, in embodiments, the underbelly portion 34 can be integrated into the garment 10. In other embodiments, the garment 10 does not include an underbelly portion 34, leaving the underside 23 of the pet exposed, which can allow the garment 10 to be put onto the pet 12, and taken off of the pet 12, with relative ease.

The present invention has been described in relation to particular embodiments, which are intended in all respects to be illustrative rather than restrictive. Alternative embodiments will become apparent to those of ordinary skill in the art to which the present invention pertains without departing from its scope. For example, in some embodiments, the garment 10 can include one or more pockets integrated into the outside surface 36 of the garment 10 (e.g., for holding treats, waste containers, toys, etc.). Additionally, in embodiments, the garment 10 can include any number of different colors, designs, embellishments, and the like. For example, in some embodiments, the garment 10 includes one or more regions of reflective material to facilitate visibility of the pet 12 in the dark. It will be understood that certain features and subcombinations are of utility and may be employed without reference to other features and subcombinations. This is contemplated by and is within the scope of the claims.

What is claimed is:

1. A garment for a pet, comprising:
a body portion that covers at least a portion of a body of the pet;
at least one leg portion extending from the body portion, wherein the at least one leg portion covers at least a portion of a leg of the pet; and
at least one foot portion extending from a lower end of the at least one leg portion, wherein the at least one foot portion covers at least a portion of a foot of the pet, and wherein an underside of the body portion is open from a front to a rear of the body portion.

2. The garment of claim 1, further comprising at least one of an anterior opening, a posterior opening, and a lower opening.

3. The garment of claim 1, further comprising a foot-retention mechanism that facilitates retention of the foot of the pet within the at least one foot portion.

4. The garment of claim 1, further comprising a foot-reinforcement region disposed at a lower end of the at least one leg portion.

5. The garment of claim 4, wherein the foot-reinforcement region comprises a tread feature.

6. A garment for a pet, comprising:
a body portion that covers at least a portion of a body of the pet;
at least one leg portion extending from the body portion, wherein the at least one leg portion covers at least a portion of a leg of the pet; and
at least one foot portion extending from a lower end of the at least one leg portion, wherein the at least one foot portion covers at least a portion of a foot of the pet, and wherein the body portion, the at least one leg portion, and the at least one foot portion are formed of a single piece of material.

7. The garment of claim 6, wherein the single piece of material comprises fleece material.

8. The garment of claim 6, further comprising a foot-retention mechanism that facilitates retention of the foot of the pet within the at least one foot portion.

9. The garment of claim 6, further comprising a foot-reinforcement region disposed at a lower end of the at least one foot portion.

10. The garment of claim 9, wherein the foot-reinforcement region comprises a tread feature.

11. A mountain pawsuit for a pet, comprising:
a body portion that covers a top and both sides of a body of the pet;
four leg portions extending from the body portion, wherein each of the four leg portions covers at least an outside of a leg of the pet; and
a foot portion extending from a lower end of each of the four leg portions, wherein the at least one foot portion entirely covers a foot of the pet, and wherein the body portion, the four leg portions, and the foot portions are formed of a single piece of material, and wherein an underside of the body portion is open from a front to a rear of the body portion.

12. The mountain pawsuit of claim 11, wherein the single piece of material comprises fleece material.

13. The mountain pawsuit of claim 11, further comprising an extra layer of material inside of each of the four leg portions, the extra layer of material configured to provide additional warmth and padding.

14. The mountain pawsuit of claim 11, wherein each of the four leg portions comprises a foot-reinforcement region.
